(19) United States
(12) Patent Application Publication
(10) Pub. No.: US 2007/0111163 A1
(43) Pub. Date: May 17, 2007

(54) Dental implant system

(76) Inventors: Theodore M. Powell, West Palm Beach, FL (US); Michael Benner, Sanford, FL (US); Robert L. Holt, West Palm Beach, FL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/591,700

(22) Filed: Nov. 2, 2006

Related U.S. Application Data
(60) Provisional application No. 60/732,471, filed on Nov. 2, 2005.

(51) Int. Cl. A61C 8/00

(52) U.S. Cl. 433/173

(57) ABSTRACT

A dental implant system comprises a dental implant, a first component, and a second component. The dental implant has a lower section for engaging bone, a middle section for passing through gingiva, and a top section with a first non-rotational feature. The first component has a larger width dimension than the implant such that a first lower portion of the first component surrounds the middle section of the implant. The first lower portion has a first scalloped lowermost end surface assisting to form the gingiva around the middle section of the implant. A second component attaches to the implant after the first component. The second component has a second lowermost portion with a second scalloped lowermost end surface that is substantially similar to the first scalloped lowermost end surface. The system may include a driver mechanism with a scalloped lowermost surface that helps to drive the implant into bone.

### RELATED APPLICATIONS

This application claims the benefit of U.S. Provisional Patent Application No. 60/732,471 filed on Nov. 2, 2005 and entitled “Dental Implant System” and this provisional application is hereby incorporated by reference in its entirety.

### FIELD OF THE INVENTION

This invention relates generally to dental implants and, in particular, to a dental implant that extends through the gingiva and to associated tools and restorative and prosthetic components.

### BACKGROUND OF THE INVENTION

It is becoming more common to replace a missing tooth with a prosthetic tooth that is placed upon and attached to a dental implant. The dental implant serves as the artificial root that integrates with the bone tissue of the mouth. The prosthetic tooth preferably has a size and color that mimics the missing natural tooth. Consequently, the patient has an aesthetically pleasing and structurally sound artificial tooth.

One current surgical protocol by which implants are integrated into the patient involves two stages. In the first stage, the implant is inserted into the jawbone, covered by suturing the overlying gingival tissue, and allowed to osseointegrate for a period of two to four months. Covering the implant with the overlying gingiva minimizes the likelihood of infection around the implant and is believed to guard against disturbances that may slow its rate of osseointegration. The implants used in the two stage protocol are sometimes referred to as “subgingival implants.”

After osseointegration is complete, the second stage is encountered in which the gingiva is again cut open and a gingival healing abutment is placed onto the implant. The overlying gingiva is sutured to allow it to properly heal around the healing abutment. When the healing abutment is removed and the prosthetic tooth is placed on the implant, the gingiva nicely conforms around the prosthetic tooth. It typically takes four to eight weeks, however, before the gingiva is healed. Thus, the overall procedure may take three to six months.

Another implant surgical protocol requires one stage and uses an implant called a “transgingival implant” or “single-stage implant” that simultaneously promotes osseointegration and healing of the gingiva. This is accomplished by providing an implant that has a portion that integrates with the jawbone and a portion that extends through the overlying gingiva so that the gingiva properly heals therearound. Thus, the four to eight week gingival healing process in the two stage process occurs during the two to four month period of osseointegration. Consequently, the patient is fitted with a prosthesis in a shorter period of time. And, the gingiva is lacerated and sutured one less time compared with two stage systems which reduces the trauma to that region, the discomfort experienced by the patient, and minimizes the overall cost.

Additionally, some clinical studies suggest that the interface between the subgingival implant and the mating abutment in a two-stage process creates bone resorption in the region adjacent to the interface. As such, transgingival implants, which lack such an interface in the bone region, should not produce the same amount of bone resorption. Additionally, because the gingival height often follows the underlying bone, a transgingival implant may minimize the reduction in the gingival height associated with bone resorption, thereby maintaining proper aesthetics.

The present invention is directed to an improved transgingival implant system including an implant, a installation system for driving the implant into the bone, and components that mate with the implant. Such a system should help the clinician maintain proper gingival height and shape.

### SUMMARY OF THE INVENTION

The present invention relates to a new dental implant system, comprising a dental implant and a mating component. The implant has a lower section for engaging bone, a middle section for passing through the gingiva, and a top section with a first non-rotational feature. The mating component has a second non-rotational feature for mating with the first non-rotational feature of the dental implant. The mating component has a larger width dimension than the dental implant such that a lower portion of the mating component surrounds the middle section of the dental implant and the top section of the dental implant is located within the component. The lowermost surface of the mating component is preferably scalloped.

In another aspect, the dental implant system comprises a dental implant, a first component, and a second component. The dental implant has a lower section for engaging bone, a middle section for passing through the gingiva, and a top section with a first non-rotational feature. The first component has a larger width dimension than the dental implant such that a first lower portion of the first component surrounds the middle section of the dental implant. The first lower portion has a first scalloped lowermost end surface assisting to form the gingiva around the middle section of the dental implant. A second component attaches to the dental implant after the first component. The second component has a second lowermost portion with a second scalloped lowermost end surface that is substantially similar to the first scalloped lowermost end surface of the first component.

The invention is a method for installing a dental implant. The method includes engaging the dental implant to a driver mechanism. The engaging includes mating corresponding non-rotational features of the driver mechanism and the dental implant. The driver mechanism telescopes over the dental implant such than an upper segment of the implant is located within the driver mechanism and a lowermost end surface of the driver mechanism is located along an exterior side surface of the dental implant. The method further includes placing the dental implant into a hole in the bone by applying force to the driver mechanism. The method may further include attaching related components to the implant after the driver mechanism is removed. The related components and the driver mechanism may have substantially matching scalloped lowermost surfaces. The driver mechanism can be a driver mount that is pre-packaged with the dental implant or a driver tip, which directly engages the implant and which is coupled to a mechanical or manual drive mechanism.

The above summary of the present invention is not intended to represent each embodiment, or every aspect, of the present invention. This is the purpose of the Figures and the detailed description which follow.

### BRIEF DESCRIPTION OF THE DRAWINGS

The foregoing and other advantages of the invention will become apparent upon reading the following detailed description and upon reference to the drawings.

FIGS. 1A, 1B, and 1C are a side view, an end view, and a cross-sectional view respectively, of an implant according to the present invention;

FIGS. 2A, 2B, and 2C are a side view, an end view, and a cross-sectional view, respectively, of an implant mount used with the implant of FIG. 1 for installing the implant in bone;

FIGS. 3A, 3B, 3C and 3D are a side view, an end view, a cross-sectional view, and an isometric view, respectively, of a gingival healing cap used with the implant of FIG. 1;

FIGS. 4A, 4B, 4C and 4D are a side view, an end view, a cross-sectional view, and an isometric view, respectively, of an impression coping used with the implant of FIG. 1;

FIGS. 5A, 5B, 5C are a side view, an end view, and a cross-sectional view, respectively, of a temporary cylinder for use with the implant of FIG. 1;

FIGS. 6A, 6B, 6C and 6D are a side view, an end view, a cross-sectional view, and an isometric view, respectively, of a permanent cylinder for use with the implant of FIG. 1;

FIG. 7 is a side view of an alternative implant having a ceramic central portion;

FIG. 8 is a side view of an alternative implant that is of a two-piece construction; and

FIG. 9 is a side view of a driver tip that is used for directly engaging the implant to drive it into the bone.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE DRAWINGS

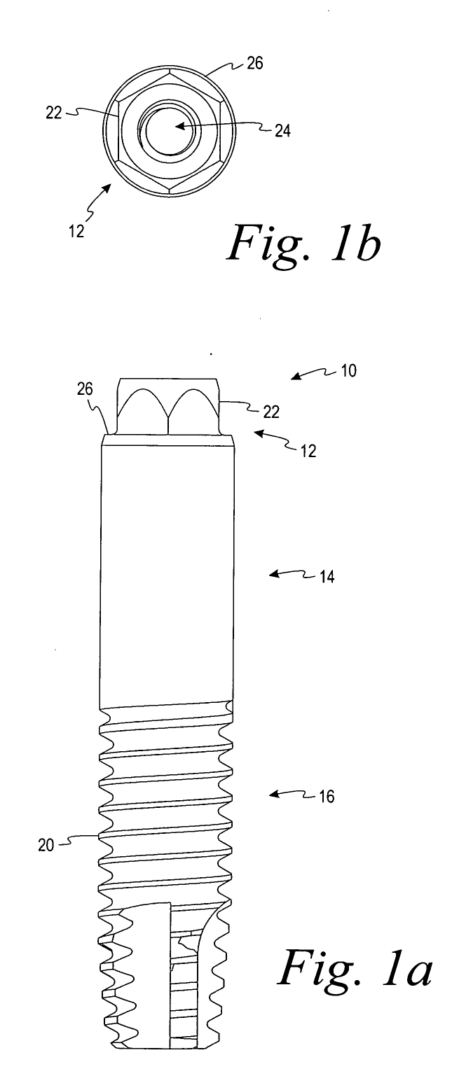

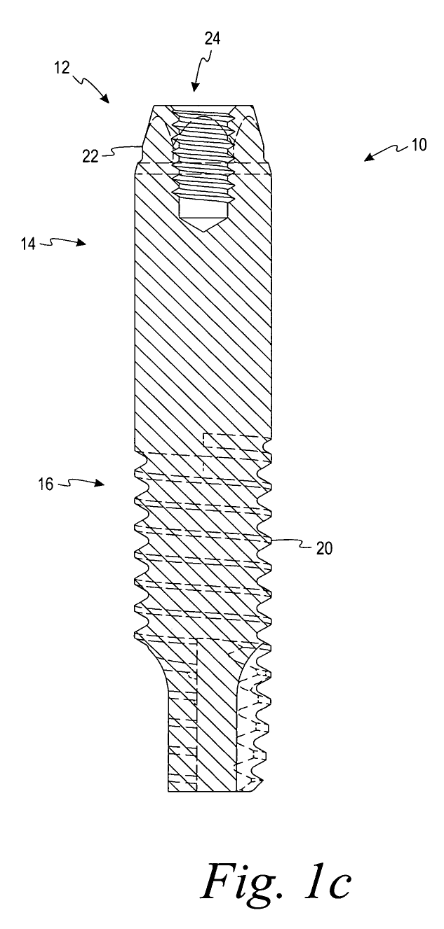

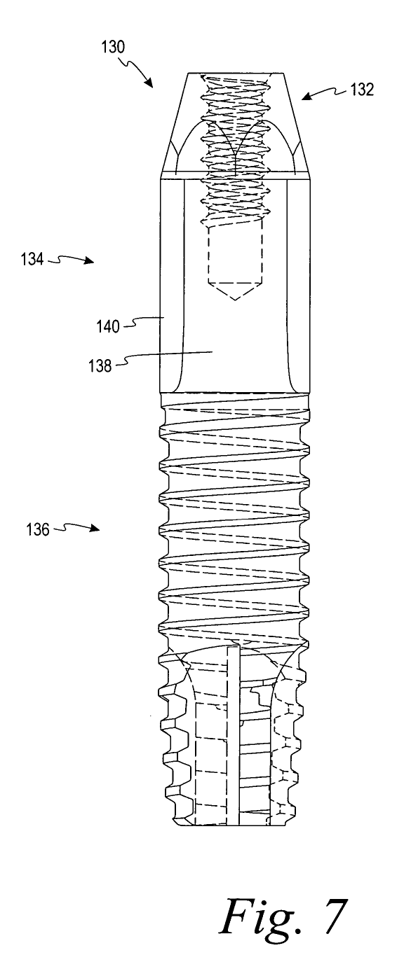

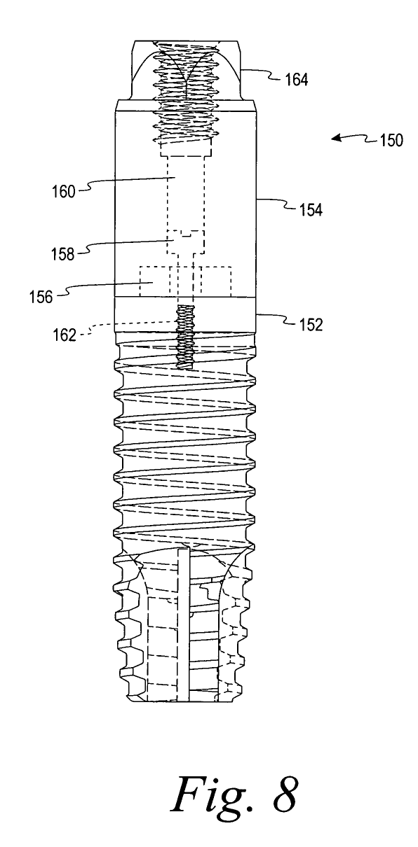

FIGS. 1A-1C illustrate an implant 10 that includes an upper section 12, a middle section 14, and a threaded lower section 16. The implant 10 is preferably made of titanium or a titanium alloy, although other materials such as ceramics or ceramic-titanium combinations are possible. FIGS. 7-8, which are discussed below, describes an alternative implant designs that have a similar shape to the implant 10 of FIG. 1.

In the implant 10 of FIG. 1, the exterior of the threaded lower section 16 includes a thread 20 that makes a plurality of turns around the implant. 10. The threaded portion preferably includes a self-tapping region that allows the implant 10 to be installed without the need for a bone tap.

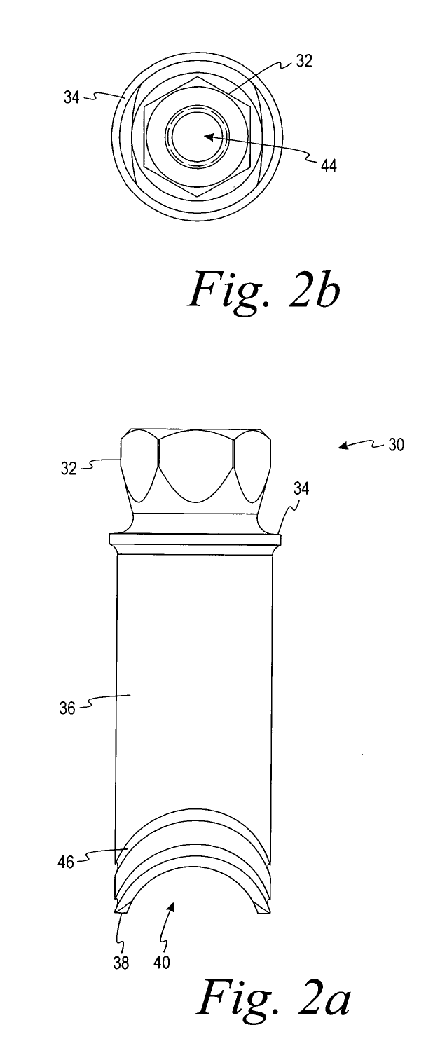

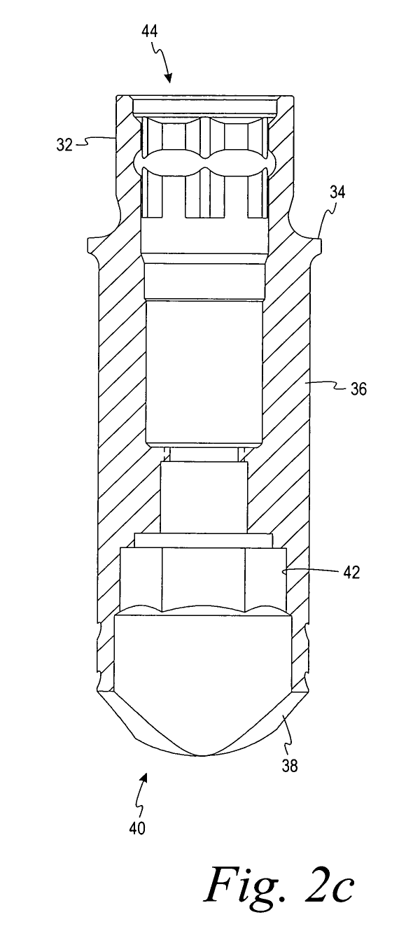

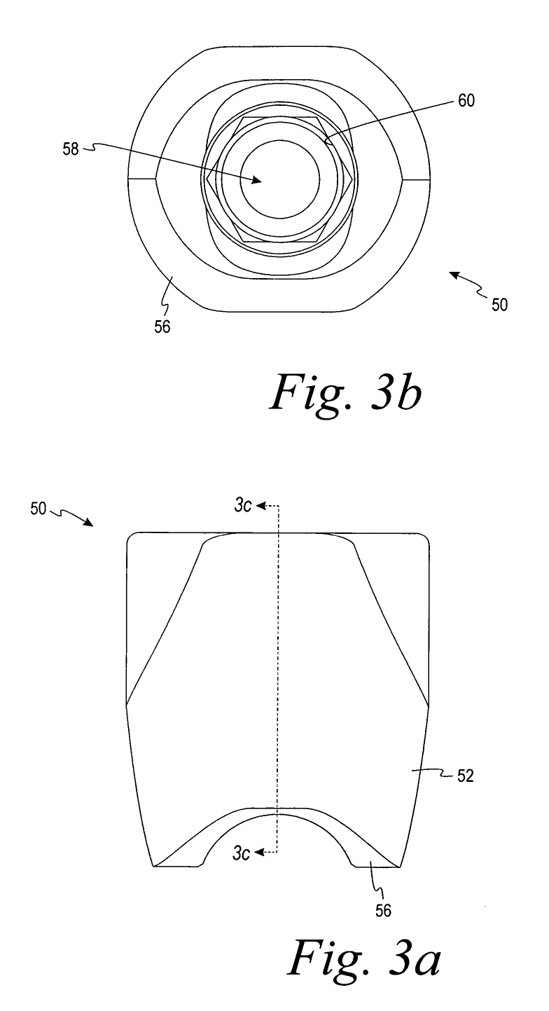

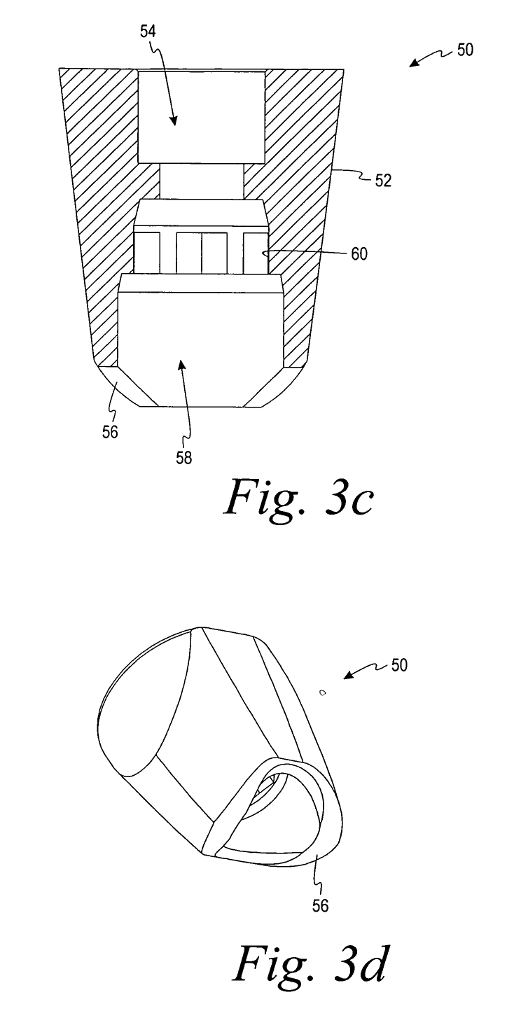

The upper section 12 includes a polygonal boss 22 (as shown, a hexagonal boss) that is useful for engaging the tool (e.g., the implant mount in FIG. 2) that applies torque to the implant 10 when the implant 10 is being installed. The polygonal boss 22 is also used for non-rotationally engaging a correspondingly shaped socket on a restorative or prosthetic component (see FIGS. 3-6) that is attached to the implant 10. The upper section 12 also includes the opening to a threaded bore 24 for receiving a screw that retains the restorative or prosthetic component on the implant 10.

At the base of the polygonal boss 22, the upper section 12 includes a table 26, which can be used to support a component mounted thereon. The polygonal boss 22, as shown best in FIG. 1B, has tapered side surfaces extending at least along a portion from the end surface of the polygonal boss 22 toward the table 26.

The middle section 14 is designed to extend through the gingiva. Preferably, it is a smooth surface that includes a titanium nitride coating so the underlying titanium or titanium alloy is not readily seen through the gingiva. The lower threaded section 16 can include various thread structures and is preferably roughened to increase the osseointegration process. Several preferred roughening processes are disclosed in U.S. Pat. Nos. 5,603,338, 6,491,723, and 6,652,765, which are herein incorporated by reference in their entireties.

FIGS. 2A-2C illustrate an implant mount 30 that is used for installing the implant 10 of FIG. 1 in bone. The implant mount 30 includes an non-rotational portion 32 that engages a drive mechanism, which can be either manually driven or power driven. As shown, the non-rotational portion 32 is a hexagonal boss at the uppermost end of the implant mount 30. Other shapes and locations for the non-rotational portion 32 are also possible. A stop surface 34 is located below the non-rotational portion 32 to limit the axial movement of the drive mechanism with respect to the implant mount 30.

The implant mount 30 includes a lower portion 36 that is used for engaging a dental implant 10 of FIG. 1. The lower portion 36 includes a lowermost end surface 38 that has a scalloped shape. Furthermore, the lower portion 36 includes an axial socket 40 into which the upper section 12 and a portion of the middle section 14 of the implant 10 (FIG. 1) is inserted. The axial socket 40 includes a correspondingly shaped non-rotational region 42 for mating with the polygonal boss 22 of the implant 10. The implant mount 30 is axially held on to the implant 10 by the use of a screw (not shown) that extends through a top opening 44 of the implant mount 30.

In a typical arrangement, the implant mount 30 is prepackaged in a sterile environment with the implant 10 attached thereto. The implantation site is prepared with an opening in the gingiva (typically, “flapless surgery”) and an osteotome to the correct depth within the bone. The clinician opens the sterile package, attaches the drive mechanism to the non-rotational portion 32 of the drive mount 30, and installs the implant 10 to the appropriate depth in the osteotomy. Grooves 46 may be provided at known distances (e.g., 1 mm spacing) from the lowermost end surface 38 of the implant mount 30 to inform the clinician of the depth of insertion below the gingiva's exterior surface. After installation is complete, the screw is removed from the top opening 44 and the implant mount 30 is detached from the implant 10. Alternatively, the clinician can attach the implant mount 30 to the implant 10 prior to installation if the implant 10 is not provided to the clinician with a pre-attached implant mount.

As will be discussed below, the scalloped-shaped end surface 38 has the same profile as other restorative and prosthetic components that are attached to the implant 10. Consequently, when the clinician installs the implant 10 with the drive mechanism, the clinician can visually verify the position of the scalloped-shaped end surface 38 to ensure that it is properly aligned to the desired gingival contour at the implantation site. Because the scalloped-shaped end surface 38 is “timed” with the non-rotational region 42 that mates with the polygonal boss 22, when other mating restorative and prosthetic components are attached to the implant 10 via the polygonal boss 22, their lowermost surfaces will fit around the middle section 14 of the implant 10 in the same manner as the lowermost end surface 38 of the implant mount 30.

After the implant 10 has been installed, it is often necessary to shape the gingiva around the implant 10 as the gingiva heals. This function can be accomplished by a healing cap 50, which is shown in FIGS. 3A-3D. The healing cap 50 is preferably made of a polymeric material, such as PEEK, although other materials will work as well. The healing cap 50 includes a main body 52 having an opening 54 had its upper end. The main body 52 includes a lowermost end surface 56 that is scalloped in the same shape as the lowermost end surface 38 of the implant mount 30. A lower socket 58 receives the top section 12 and a portion of the middle section 14 of the implant 10 of FIG. 1. The lower socket 58 includes a non-rotational portion 60 for engaging the polygonal boss 22 of the implant 10.

Once the implant 10 is installed and the healing cap 50 is placed over the implant 10, the gingiva can be sutured (if needed) around the combination of the implant 10 and healing cap 50. Over the next several weeks, the gingiva will heal to shape that corresponds to the scalloped shape of the lowermost end surface 56 of the healing cap 50. The lowermost end surface 56 acts to limit the height of the gingival growth. Hence, the desired shape of the gingiva around the implantation site can be substantially controlled by the shape and size of the healing cap 50 that is used.

Furthermore, the healing cap 50 preferably has a wider lowermost surface 56 (in the radial direction with respect to the central axis of the implant 10) than the lowermost surfaces of the other mating components (discussed below) that are later mated with the implant 10. When the healing cap 50 is removed, the gingiva may collapse towards the middle section 14 of the implant 10. If the other components have thinner lowermost surfaces, then they will fit easier into the gingival opening produced by the healing cap 50. The shape of the healing cap 50 may taper outwardly to develop more of an aesthetic emergence profile through the gingiva.

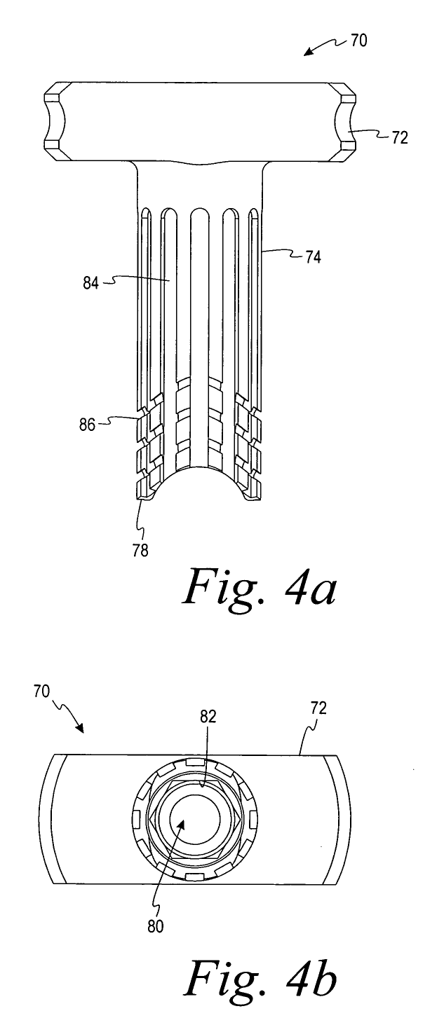

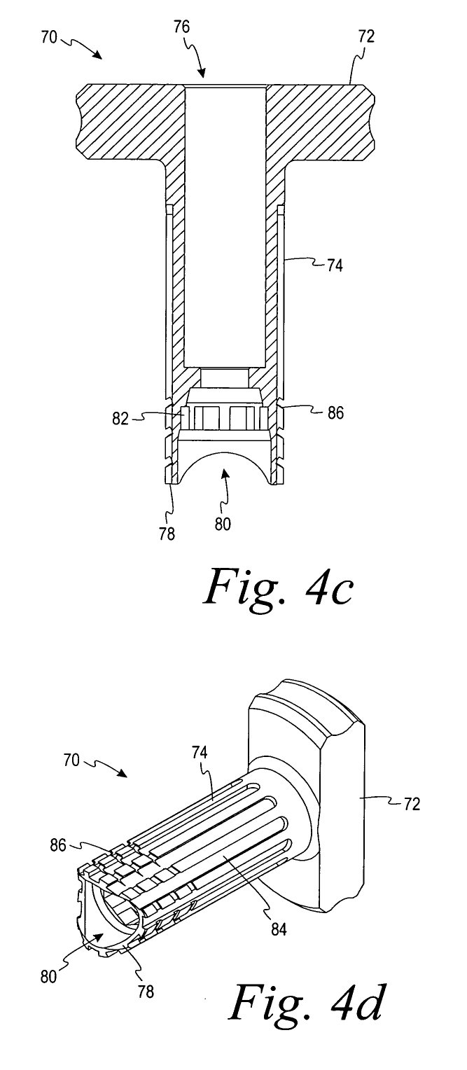

To make an impression of the implantation site, an impression coping 70, which is shown in FIGS. 4A-4D, is attached to the implant 10 of FIG. 1. The impression coping 70 is preferably made of a polymeric material, such as PEEK, or it may be CP titanium, titanium alloy, or other materials. The impression coping 70 includes a top portion 72 and a main body 74 that become encased in impression material. An axial hole 76 receives a screw (not shown) to hold the impression coping 70 on the implant 10.

The main body 74 includes a lowermost surface 78, which is scalloped in the same manner as provided with the previous components. The main body 74 also includes a lower socket 80 that includes a non-rotational region 82 for engaging the polygonal boss 22 of the implant 10. The impression coping 70 may include a plurality of axial grooves 84 along the main body 74 as well as a plurality of grooves 86 adjacent the lowermost surface 78. The purpose of these grooves 84 and 86 is to help retain the impression material on the impression coping 70. The plurality of grooves 86 also helps the clinician to identify the depth below the gum tissue that the impression coping 70 is inserted.

In one method, after the healing cap 50 of FIG. 3 is used to develop the shape of the gingiva, the healing cap 50 is removed. Then, the impression coping 70 is placed over the implant 10 and is affixed to the implant 10 by a screw (not shown), which has a long head portion that extends well above the impression coping 70. The clinician can then place impression material around the impression coping 70 and the adjacent teeth. After the impression material hardens, the screw can be released and the entire impression, including the impression coping 70, is removed from the patient's mouth. A corresponding implant analog is attached to the impression coping 70. A stone model is then poured within the impression, providing a model of the implantation site that includes the implant analog at the location and orientation corresponding to the implant 10 within the bone. Because the scallop of the impression coping 70 is substantially the same as the healing cap 50, the scallop of the impression coping 70 should substantially correspond to the gingival shape after the gingiva has healed around the healing cap 50. Alternatively, the scallop of the impression coping 70 may be slightly shorter than the scallop of the healing cap 50 (e.g., 1 mm shorter) so that the impression material can engage the gingival tissue below the scallop of the impression coping 70 to capture its exact shape.

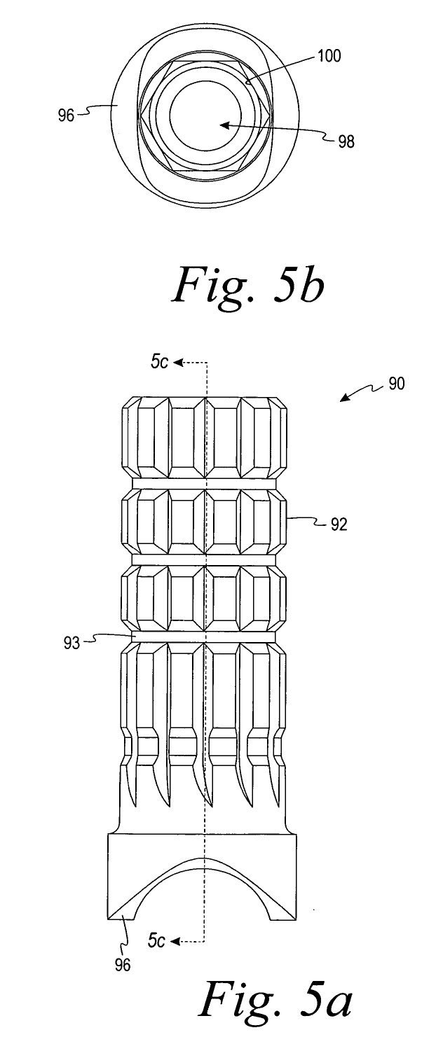

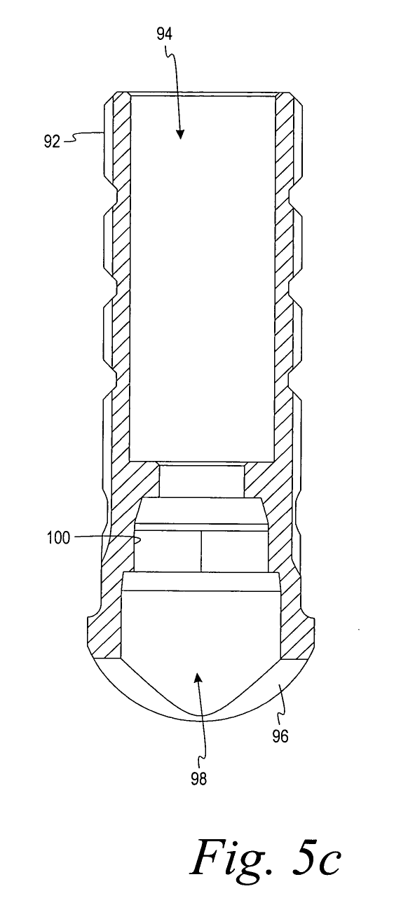

FIG. 5 illustrates a temporary cylinder 90 that can be used to receive tooth-like material (e.g., acrylic) to develop a temporary tooth for the patient while a final prosthesis is being developed by a laboratory. The temporary cylinder 90 includes a main body 92 having a plurality of axial and circumferential grooves 93 for receiving and holding the tooth-like material. The main body 92 includes an axial hole 94 for receiving a screw to hold the temporary cylinder 90 on the implant 10. Like the previously discussed components, the lowermost end 96 of the main body 92 has a scalloped shaped. Additionally, a lower socket 98 for receiving the implant 10 includes a non-rotational region 100 for engaging the polygonal boss 22 of the implant 10. It should be noted that it is possible to avoid the use of the healing cap 50 of FIG. 3 and simply use the temporary cylinder 90 to restrict and control the gingival shape while also providing for the temporary prosthetic tooth.

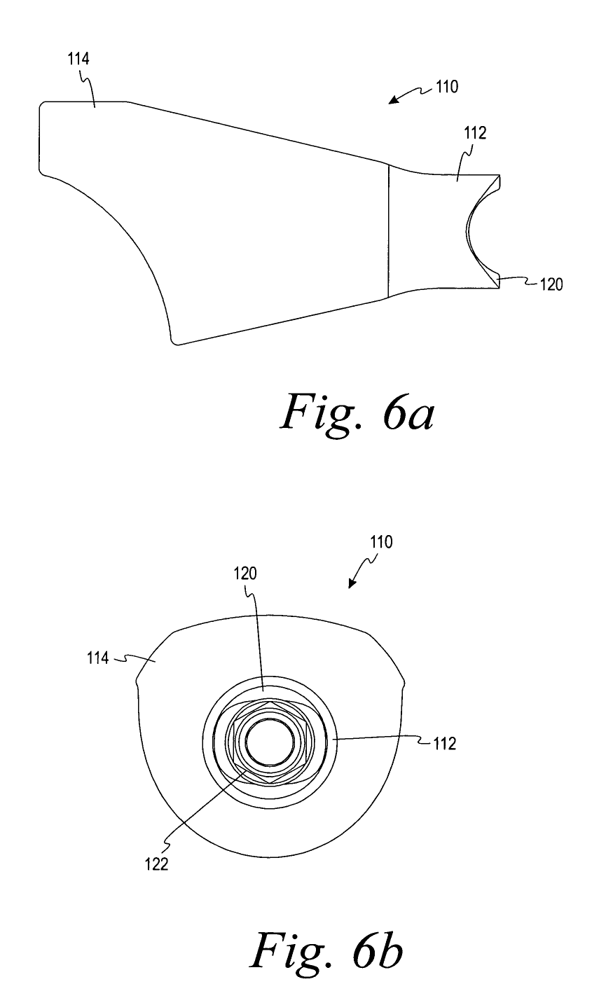

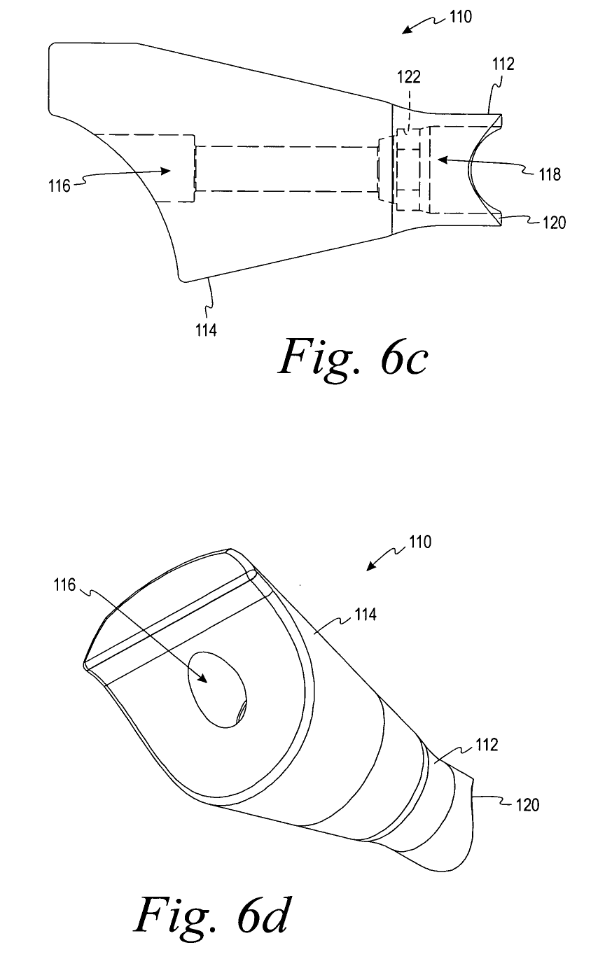

FIG. 6 illustrates a permanent cylinder 110 that can be made from a variety materials, such as titanium or, preferably, a ceramic material such as zirconium oxide. The permanent cylinder 110 includes a lower portion 112 and an upper portion 114, which is shaped generally like the shape of the tooth being replaced. As such, various shapes may be available for the permanent cylinder 110. The upper portion 114 includes an axial hole 116 for receiving a screw to hold the permanent cylinder 110 on the implant 10. The lower portion 112 includes an axial socket 118 for receiving the implant 10 and a scalloped lowermost end surface 120, which corresponds to the scallop provided on the previous components. The axial socket 118 includes a non-rotational region 122 for mating with the polygonal boss 22 of the implant 10.

In operation, the permanent cylinder 110 receives permanent tooth-like material (e.g., porcelain) in a laboratory that is used to develop the final prosthesis from the impression of the patient's mouth. As such, the tooth-like material adheres to the outer surface of the upper portion 114 and possibly segments of the lower portion 112. When the final prosthesis is sent to the clinician from the laboratory, the clinician can remove the previous components that were used (e.g., the healing cap 50 if it is still in place, or the temporary cylinder 90 with its temporary tooth) and install the final prosthesis via a screw through the axial hole 116. The screw hole 116 can be filled with other tooth-like material by the clinician.

FIG. 7 illustrates an alternative implant 130 that has the same general shape as the implant 10 of FIG. 1. Specifically, the implant 130 includes a top section 132, a middle section 134, and a lower section 136. The middle section 134 includes an internal metallic core 138 and a ceramic outer portion 140. The ceramic outer portion 140 can be one of many types of ceramics, such as zirconium oxide. The ceramic outer portion 140 can be sprayed on to the metallic core 138, or a sheath (or sheath sections) can be placed around the metallic core 138 and held there via a glue or epoxy. The implant 130 can be used with the various components described with respect to FIGS. 2-6 and provides additional aesthetic benefits when compared to an entirely metallic implant.

FIG. 8 illustrates yet another alternative implant 150 that has the same general shape as the implant 10 of FIG. 1. The implant 150, however, is constructed of two primary pieces—a lower implant portion 152 and an upper implant portion 154. The lower implant portion 152 and the upper implant portion 154 are held together through a non-rotational connection 156 (e.g., a hexagonal boss and a corresponding hexagonal socket) and an axial screw 158. The axial screw 158 is inserted into a through bore 160 in the upper implant portion 154 and mates with a threaded bore 162 within the lower implant portion 152. The only external difference between the implant 10 of FIG. 1 and the implant 150 of FIG. 8 is the interface line between the upper implant portion 154 and the lower implant portion 152. While the interface between the lower implant portion 152 and the upper implant portion 154 is shown near the thread on the implant 150, it can be located substantially closer to the uppermost non-rotational boss 164, such that the upper implant portion 154 is much shorter. In any event, the implant 150 can be used with the various components prescribed with respect to FIGS. 2-6.

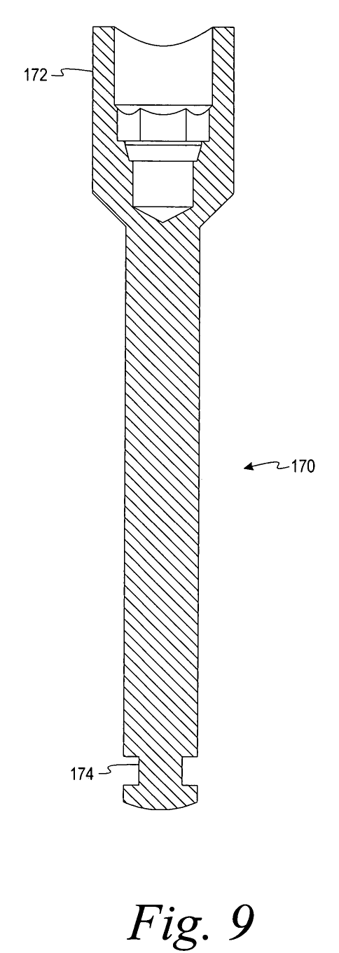

FIG. 9 illustrates an alternative drive mechanism that is useful for installing the implant via a direct-drive technique. A driver tip 170 includes a lower end 172 that is shaped and configured in a similar manner as the lower end of the driver mount 30 of FIG. 2. The lower end 172 fits around the implant 10 and non-rotationally engages the implant. When torque is applied to an upper end 174 of the driver tip 170, which includes a latch mechanism (e.g., an ISO-latch), the implant 10 can be installed into the bone. As such, the dental implant 10 does not need to be pre-packaged with the driver mount 30 (FIG. 2) and the driver tip 170 may be reusable by the clinician.

The overall widths of the implant 10, the implant 130, and the implant 150 are in the range from about 2.75 mm to about 6.0 mm. The present invention contemplates that the components described in FIGS. 2-6 will be provided in kits (preferably, color coded) for mating with the various sizes of the dental implants.

The present invention also contemplates a series of restorative and prosthetic components as shown in FIGS. 2-6 having different dimensions and shapes for the scalloped lowermost surfaces. In other words, a first patient may require a deeper scallop, resulting in a longer circumferential path along the lowermost end surfaces of these components. Yet, a second patient may require or a shallower scallop, resulting in a shorter circumferential path along the lowermost end surfaces of these components. In these situations, the driver mount 30 (FIG. 2) may still have the same scallop for each patient since the scalloped lowermost end surface on the driver mount 30 is for helping the clinician to identify the relative positions of scalloped lowermost end surfaces of the restorative and prosthetic components when they are attached to the implant after the driver mount 30 has been removed.

It should also be noted that the middle section 14 of the implant 10 may include a microstructure, a treatment, or an additive that encourages the growth and attachment of the gingival tissue. As such, when the healing cap 50 (FIG. 3) or the temporary cylinder 90 (FIG. 5) is telescoped over the middle section 14 of the implant, the healing cap 50 or the temporary cylinder 90 acts as a mask such that only the exposed portion of the middle section 14 having such a microstructure, a treatment, or additive will encourage growth of the gingival tissue. Some exemplary methods for encouraging the growth and attachment of the gingival tissue include nano-particle deposition, collagen treatment or embedment, or an antimicrobial surface.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for installing a dental implant, comprising:
engaging said dental implant to a driver mechanism, said engaging including mating corresponding non-rotational features of said driver mechanism and said dental implant, said driver mechanism telescoping over said dental implant such than an upper segment of said implant is located within said driver mechanism and a lowermost end surface of said driver mechanism is located along an exterior side surface of said dental implant; and
placing said dental implant into a hole in said bone by applying force to said driver mechanism.

2. The method of claim 1, wherein said lowermost end surface of said driver mechanism is scalloped.

3. The method of claim 2, wherein said non-rotational features have polygonal cross-sections.

4. The method of claim 3, wherein said non-rotational features taper in a direction away from the lowermost end surface of said driver mechanism.

5. The method of claim 1, wherein said exterior side surface of said dental implant is generally cylindrical.

6. The method of claim 1, wherein said exterior side surface of said dental implant includes a ceramic portion.

7. The method of claim 1, wherein said dental implant includes two pieces that are axially held together.

8. The method of claim 1, further including, after said placing, removing said driver mechanism and installing components on said dental implant that telescope over said dental implant.

9. The method of claim 8, wherein lowermost end surfaces of said components are scalloped in the same manner as said driver mechanism.

10. A dental implant system, comprising:
a dental implant having a lower section for engaging bone, a middle section for passing through gingiva, and a top section with a first non-rotational feature; and
a component having a second non-rotational feature for mating with said first non-rotational feature of said dental implant, said component having a larger width dimension than said dental implant such that a lower portion of said component surrounds said middle section of said dental implant and said top section of said dental implant is located within said component.

11. The system of claim 10, wherein said lower portion of said component includes a lowermost surface that is scalloped.

12. The system of claim 10, wherein said component is a gingival healing cap.

13. The system of claim 10, wherein said component is an impression coping.

14. The system of claim 10, wherein said component is a temporary cylinder for supporting a temporary dental prosthesis.

15. The system of claim 10, wherein said component is a permanent cylinder for supporting a permanent dental prosthesis.

16. The system of claim 10, wherein said component is a driver mount or a driver tip for installing the implant.

17. A dental implant system, comprising:
a dental implant having a lower section for engaging bone, a middle section for passing through gingiva, and a top section with a non-rotational feature;
a first component having a larger width dimension than said dental implant such that a first lower portion of said first component surrounds said middle section of said dental implant, said first lower portion having a first scalloped lowermost end surface assisting to form the gingiva around said middle section of said dental implant; and
a second component for attachment to said dental implant after said first component, said second component having a second lowermost portion with a second scalloped lowermost end surface that is substantially similar to said first scalloped lowermost end surface.

18. The system of claim 17, wherein said first component is a gingival healing cap.

19. The system of claim 18, wherein said second component is an impression coping.

20. The system of claim 18, wherein said second component is a temporary cylinder for receiving material to develop a temporary prosthetic tooth.

21. The system of claim 18, wherein said second component is a permanent cylinder.

22. The system of claim 21, wherein said permanent cylinder is made of ceramic.

23. The system of claim 22, wherein said permanent cylinder is in the general shape of a tooth and receives material for a final prosthetic tooth.

24. The system of claim 17, wherein said first component is a temporary cylinder for receiving material to develop a temporary prosthetic tooth.

25. The system of claim 24, wherein said second component is permanent cylinder.

26. The system of claim 17, wherein said non-rotational feature tapers in a direction away from said first scalloped lowermost end surface.

27. The system of claim 17, wherein said first scalloped lowermost end surface is wider than said second scalloped lowermost end surface.

28. The system of claim 17, wherein said middle section of said implant includes a microstructure, a treatment, or an additive that encourages the growth and/or attachment of the gingival tissue.

29. The system of claim 17, wherein said first and second components include corresponding non-rotational features for mating with said non-rotational feature on said implant.
